(19) United States
(12) Patent Application Publication
(10) Pub. No.: US 2014/0133201 A1
(43) Pub. Date: May 15, 2014

(54) UPS SYSTEMS AND METHODS USING UPS MODULES WITH DIFFERENTIAL MODE INDUCTOR COUPLING

(71) Applicant: EATON CORPORATION, Cleveland, OH (US)

(72) Inventors: Jonathan Daniel Brandmeyer, Morrisville, NC (US); Anthony Joseph Olivo, Raleigh, NC (US)

(73) Assignee: Eaton Corporation, Cleveland, OH (US)

(21) Appl. No.: 13/678,061

(22) Filed: Nov. 15, 2012

(51) Int. Cl. H02M 3/00

(52) U.S. Cl. CPC H02M 3/00
USPC 363/65

(57) ABSTRACT

An uninterruptible power supply (UPS) system includes at least two UPS modules having respective switchmode power converter circuits coupled in common to a current source/sink by respective conductors. The system further includes at least one differential mode inductor magnetically coupling the at least two conductors. For example, the switchmode power converter circuits may include respective DC/DC converter circuits coupled in common to a terminal of a DC power source, such as a battery, by the conductors. The differential mode inductors may be implemented using, for example, ferrite rings.

### BACKGROUND

The inventive subject matter relates to power conversion apparatus and methods and, more particularly, to uninterruptible power supply (UPS) apparatus and methods.

UPS systems are commonly used in installations such as data centers, medical centers and industrial facilities. UPS systems may be used in such installations to provide backup power to maintain operation in event of failure of the primary utility supply. These UPS systems often have an “on-line” configuration including a rectifier and inverter coupled by a DC link that is also coupled to an auxiliary power source, such as a battery, fuel cell or other energy storage device. Other configurations, such as standby and line-interactive configurations, may also be used.

UPS systems may have a modular structure including two or more UPS modules, each of which may include, for example, a rectifier, an inverter and a DC/DC converter for interfacing to a battery or other DC power source. The modules commonly are designed to operate in parallel to provide scalable power capacity, e.g., the modules may be coupled in common to an AC source, a DC source (e.g., a battery) and/or a load.

The converter circuits used in such UPS modules are typically switchmode power converter circuits. Paralleled arrangements of such switchmode converters may be vulnerable to the generation of significant high-frequency currents between the modules. In paralleled inverter arrangements, this problem may be addressed by, for example, synchronizing the PWM cycles used by the inverters as described, for example, in U.S. Pat. No. 7,405,494 to Tassitino, Jr. et al. In paralleled DC/DC battery conversion arrangements, large inductors may be connected in the battery connection paths to move resonant frequencies of the battery connection circuitry outside of the PWM frequency range of the DC/DC converters.

### SUMMARY

Some embodiments of the inventive subject matter provide an uninterruptible power supply (UPS) system including at least two UPS modules having respective switchmode power converter circuits coupled in common to a current source/sink by respective conductors. The system further includes at least one differential mode inductor magnetically coupling the at least two conductors.

In some embodiments, the switchmode power converter circuits may include respective DC/DC converter circuits coupled in common to a terminal of a DC power source by the conductors. The DC/DC converter circuits may operate at variable frequencies and/or may not be synchronized. The at least two UPS modules may further comprise respective inverter circuits having inputs coupled to respective ones of the DC/DC converters and outputs coupled in common to a load.

In some embodiments, the at least one differential mode inductor may include a ferrite core magnetically coupling the conductors. The ferrite core may include, for example, a ferrite ring through which each of the conductors passes at least once.

In further embodiments, the switchmode power converter circuits may include respective inverter circuits coupled in common to a terminal of a load by the conductors. In still further embodiments, the switchmode power converter circuits may include respective rectifier circuits coupled in common to a terminal of an AC power source by the conductors.

According to some embodiments, the at least two UPS modules may include at least three UPS modules having respective switchmode power converter circuits coupled in common to the current source/sink by at least three respective conductors. The at least one differential mode inductor may include a plurality of differential mode inductors, respective ones, of which magnetically couple respective pairs of the at least three conductors. At least one of the at least three conductors may be magnetically coupled to less than all of a remainder of the at least three conductors.

Some embodiments of the inventive subject matter provide a UPS system including at least two UPS modules. Each of the at least two UPS modules includes an inverter circuit having an output configured to be coupled to load and a DC/DC converter circuit coupled to an input of the inverter circuit. The system further includes at least two conductors, respective ones of which couple respective ones of the switchmode DC/DC converter circuits of the UPS modules in common to a terminal of a battery and at least one differential mode inductor magnetically coupling the at least two conductors.

Further embodiments provide methods of operating a UPS system comprising at least two UPS modules and at least two conductors, respective ones of which couple respective switchmode DC/DC converter circuits of the UPS modules in common to a terminal of a battery. The methods include differential mode inductively coupling the at least two conductors.

### BRIEF DESCRIPTION OF THE DRAWINGS

FIG. 1 is a schematic diagram illustrating a UPS system according to some embodiments of the inventive subject matter.

FIG. 2 is a schematic diagram illustrating a UPS system according to further embodiments.

FIG. 3 is a schematic diagram illustrating an implementation of a UPS module in the UPS system of FIG. 2.

FIG. 4 is a schematic diagram illustrating an implementation of differential mode inductors according to some embodiments.

FIG. 5 is a schematic diagram illustrating a UPS system according to further embodiments.

FIGS. 6 and 7 illustrate examples of differential mode inductor arrangements according to some embodiments.

FIG. 8 is a schematic diagram illustrating a UPS system according to still further embodiments.

FIG. 9 is a schematic diagram illustrating a UPS system with differential mode inductors for paralleled inverters according to some embodiments.

FIG. 10 is a schematic diagram illustrating a UPS system with differential mode inductors for paralleled rectifiers according to some embodiments.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

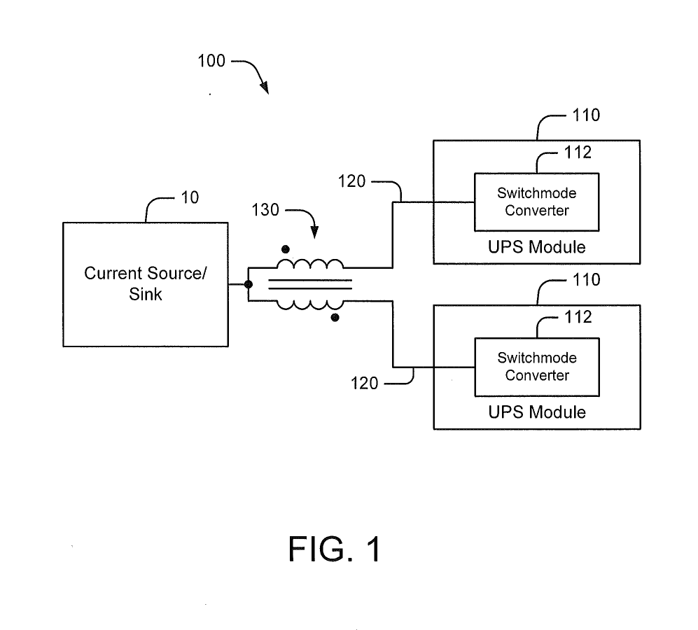

FIG. 1 illustrates a UPS system 100 according to some embodiments of the inventive subject matter. The system 100 includes at least two UPS modules 110, each of which includes at least one switch mode converter circuit 112. Ports of respective ones of the switchmode converter circuits 112 are coupled in common to at least one current source/sink 10 by respective conductors 120. As used herein, “current source/sink” refers to a device that serves as a current source and/or as a current sink, such as a power source (DC and/or AC), a load or a device that may serve as both a source and a load. At least one differential mode inductor 130 magnetically couples the conductors 120 in a differential (anti-parallel) arrangement, as indicated by polarity dots in FIG. 1. As explained in greater detail below, the switchmode converter circuits 112 may include, for example, DC/DC converter circuits, inverter circuits and/or rectifier circuits. The current source and/or sink 10 may include, for example, a battery, a utility or generator source, and/or a load, such as a load served by the UPS system 100.

Certain embodiments of the inventive subject matter may be advantageously implemented in modular UPS systems in which DC/DC battery converter circuits of multiple UPS modules are coupled in common to a DC source, such as a battery. In some systems, such DC/DC converters may be unsynchronized and/or may operate at variable PWM frequencies. Consequently, such arrangements may produce significant high frequency currents between the modules. These high frequency currents may stress interconnecting conductors and/or the components of the DC/DC converters, such as filter capacitors. Conventional techniques for mitigating such high-frequency currents, such as PWM synchronization and/or the use of large in-line inductors, may lack robustness and/or may involve undesirable cost, weight and volume.

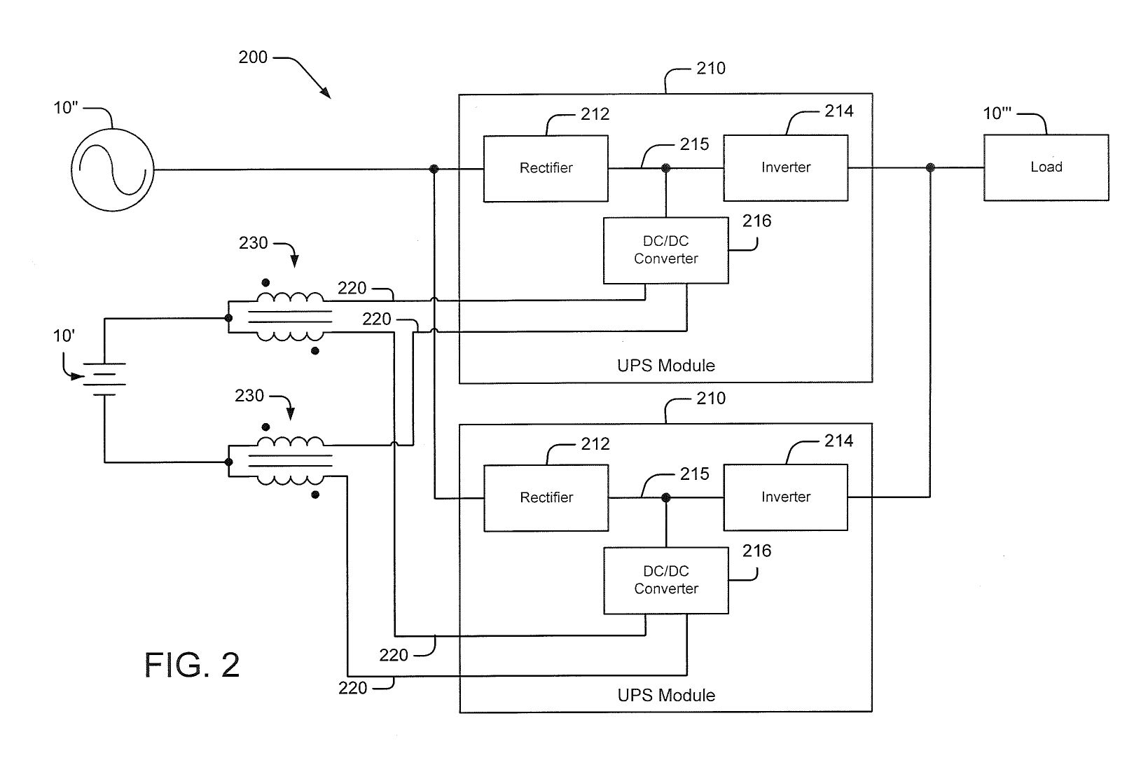

FIG. 2 illustrates a UPS system 200 according to some embodiments of the inventive subject matter. The system 200 includes at least two UPS modules 210, each of which includes a rectifier circuit 212 and an inverter circuit 214 coupled by a DC link 215. The rectifier circuits 212 may have inputs coupled in coupled in common to an AC power source 10″, such as a utility source or generator. Under normal operating conditions (i.e., when the AC power source 10″ is active), the rectifier circuits 212 generate DC voltages on the DC links 215. The inverter circuits 214 are coupled in common to a load 10′″ and generate an AC voltage to provide power to the load 10′″. The inverter circuits 214 may be operated to provide substantially equal load sharing by the UPS modules 210. Examples of load sharing techniques that may be used are described in U.S. Pat. No. 5,745,356 to Tassitino, Jr. et al. and U.S. Pat. No. 6,549,440 to Tassitino, Jr. et al., each of which is hereby incorporated by reference.

DC/DC battery converter circuits 216 are coupled to the DC links in the modules 210. Conductors 220 couple the DC/DC converter circuits 216 in common to terminals of a battery 10′. The battery 10′ (which may include one or several cells) and the DC/DC converter circuits 216 may provide auxiliary power to the inverter circuits 214 in the event that the AC power source 10″ degrades or fails. The DC/DC converter circuits 216 may also provide charging current to the battery 10′ from the DC link 215. The DC/DC converter circuits 216 may be unsynchronized and/or may operate at variable PWM frequencies.

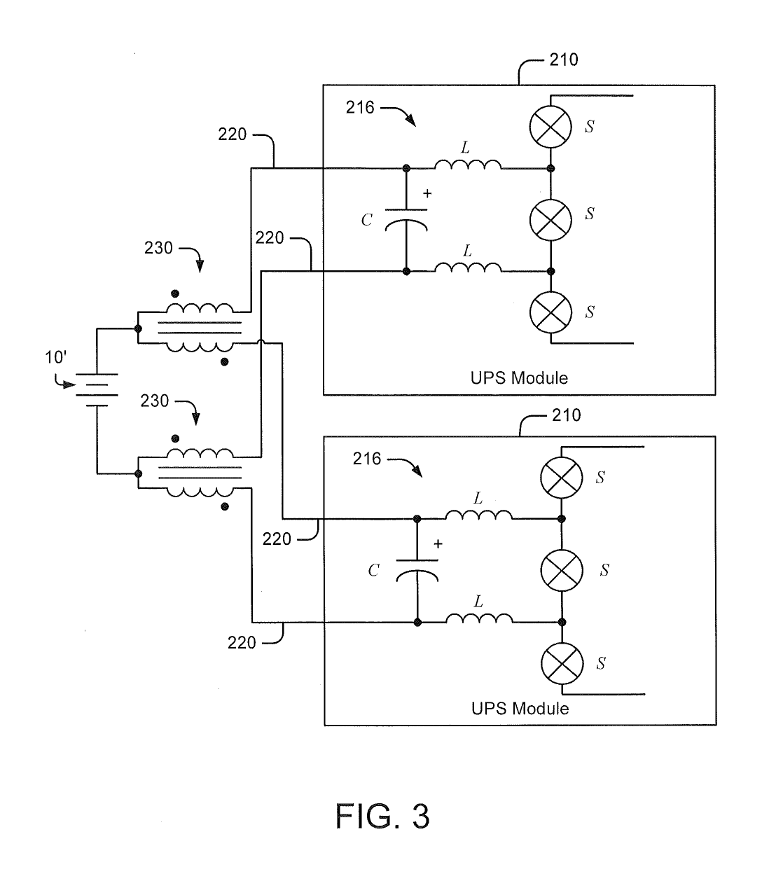

Respective differential mode inductors 230 magnetically couple respective pairs of the conductors 220, and may be configured to reduce high-frequency currents passing between the DC/DC converter circuits 216. As illustrated in FIG. 3, the DC/DC converter circuits 216 of UPS modules 210 may include input filter capacitors C that are coupled to boost circuits that include inductors L and switches S. The differential mode inductors 230 may add inductance for the currents that may be passed between the filter capacitors C of the DC/DC converter circuits 216, without adding significant common mode inductance. Because the inductors 230 are differential mode, the magnetic fields associated with the DC currents in the parallel modules may substantially cancel, as these currents may be approximately equal due to load sharing between the modules 210. Therefore, relatively small, high permeability cores may be used for the differential mode inductors 230, which can reduce volume and/or cost.

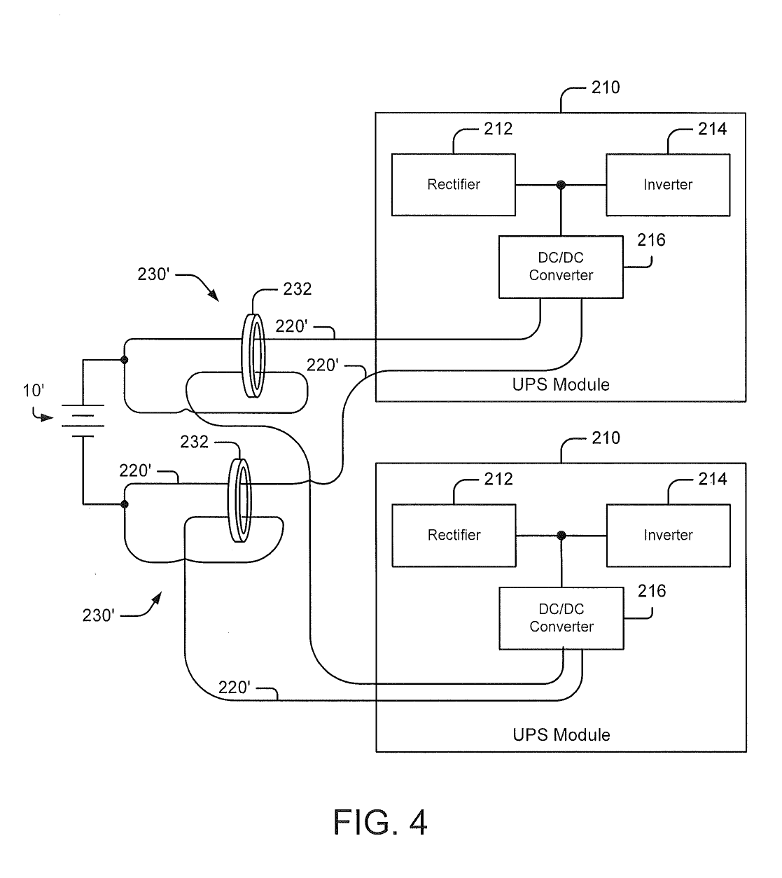

According to some embodiments, such differential mode inductors may be implemented using ferrite rings or similar structures. For example, as shown in FIG. 4, UPS modules 210 may be coupled in common to terminals of a battery 10′ using flexible conductors 220′. Differential mode inductors 230′ may be implemented by passing the cables 220′ at least once through ferrite rings 232 in a differential arrangement. It will be appreciated that other differential inductor arrangements may be used in other embodiments. For example, differential mode inductors may be implemented by wrapping conductors in a differential fashion around a core having a bar, rod or other form factor. Differential mode inductors may use any of a variety of different magnetic core materials. It will be further appreciated that differential mode inductors with similar properties may be implemented using rigid conductors, such as bus bars.

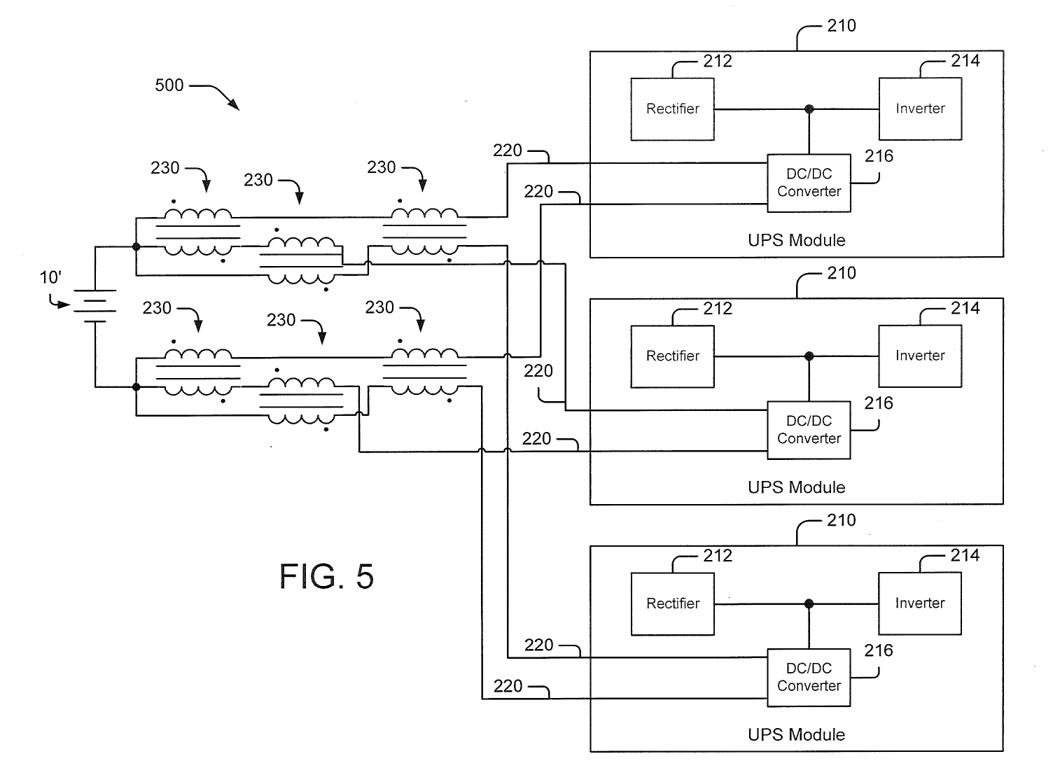

In UPS systems including more than two modules, similar functionality may be obtained by using respective differential mode inductors that couple conductors from respective pairs of modules. For example, FIG. 5 illustrates a UPS system 500 including three UPS modules 210, each including a rectifier circuit 212, and inverter circuit 214 and a DC/DC converter circuit 216. The system 500 utilizes multiple differential mode inductors 230, respective ones of which couple respective pairs of conductors 220 that couple the DC/DC converter circuits 216 to terminals of a battery 10′. FIG. 7 illustrates a configuration that may be used for a four-module implementation. In still further embodiments, differential mode inductor structures may be used that allow for more than two conductors to be magnetically coupled through a common core in a manner that provides functionality along the lines described above.

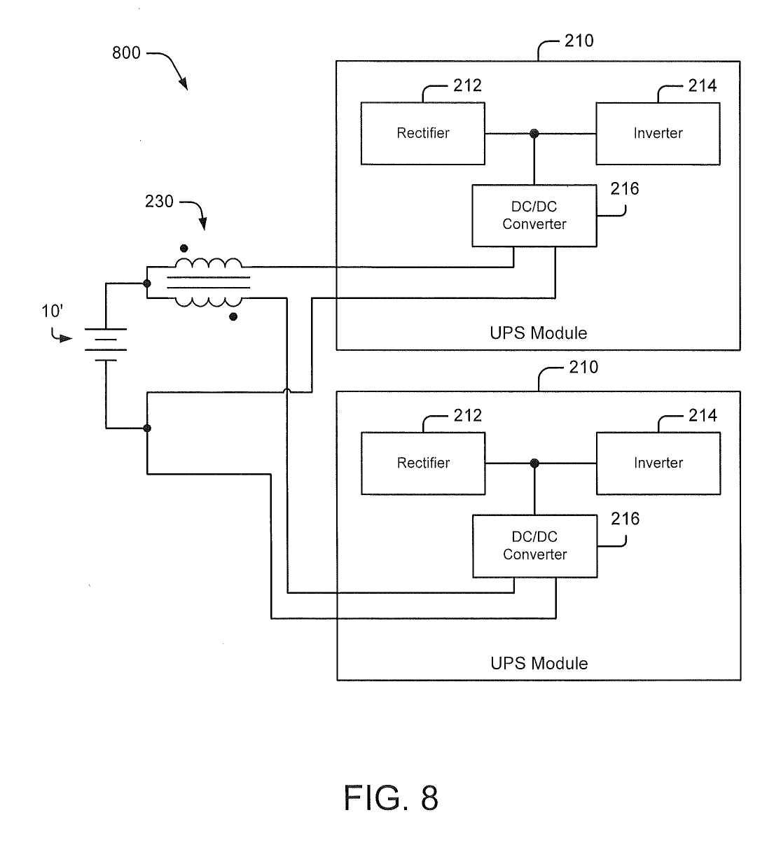

According to further embodiments illustrated in FIG. 8, a reduced number of inductors 230 may be used. For example, the inductors 230 may be limited to coupling conductors from physically adjacent UPS modules, representing a tradeoff between reduction of ripple current and volume/cost. As shown in FIG. 8, in some embodiments, a UPS system 800 may include a differential inductor for conductors 220 connected to only one terminal of a battery 10′.

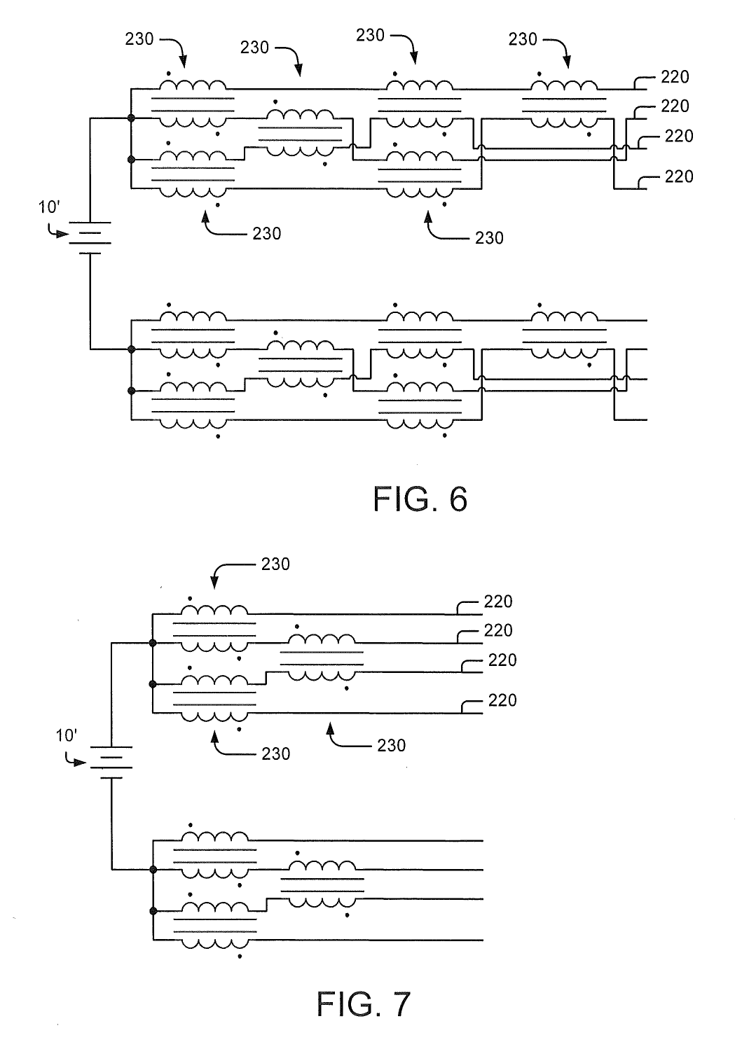

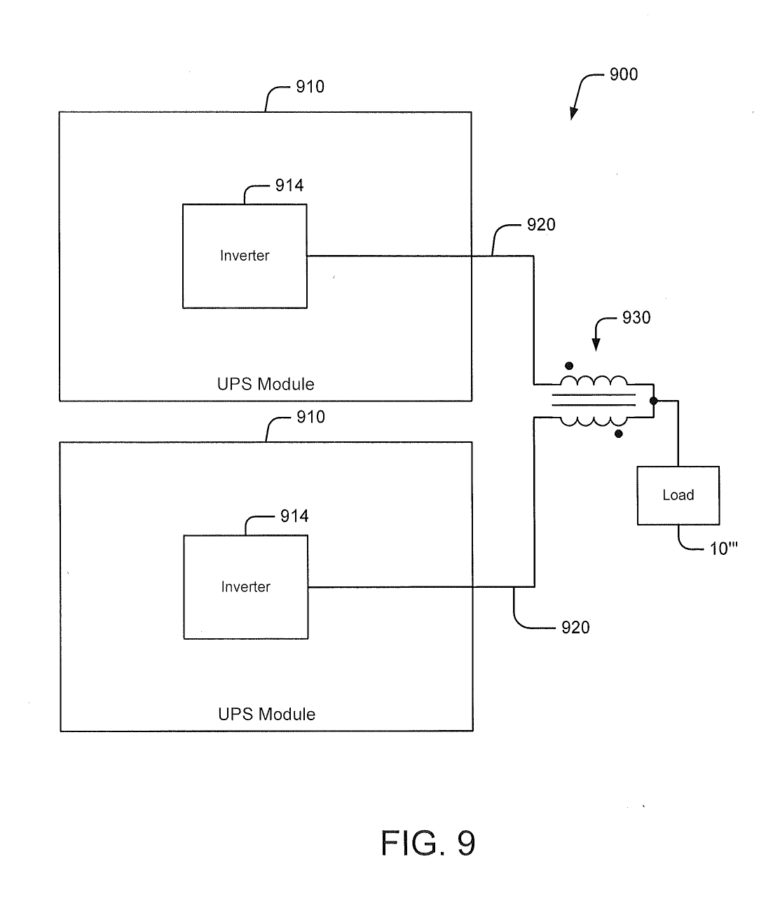

According to further embodiments, a UPS system may similarly use differential mode inductors for the conductors coupling paralleled inverters and/or rectifiers. As shown in FIG. 9, a UPS system 900 may include at least two UPS modules 910, each of which includes an inverter circuit 914. The UPS modules 910 may have an on-line configuration (e.g., as shown in FIG. 2, the modules may further include rectifier circuits and DC/DC converter circuits for battery coupling), or may have other configurations, such as standby or line-interactive configurations. Outputs of the inverter circuits 914 are coupled in common to a terminal of a load 10′″ by conductors 920. At least one differential mode inductor 930 magnetically couples the conductors 920. Such an arrangement may be used to reduce high-frequency currents passing between the inverter circuits 914, such that it may not be necessary to, for example, synchronize PWM cycles of the inverter circuits 914. The differential mode inductor 930 may be implemented using, for example, conductors coupled in a differential manner through a ferrite ring (e.g., similar to the arrangement shown in FIG. 4) and/or other differential mode inductor arrangements. In systems including three or more paralleled modules, differential mode inductor arrangements similar to those described with reference to FIGS. 5-7 may be used.

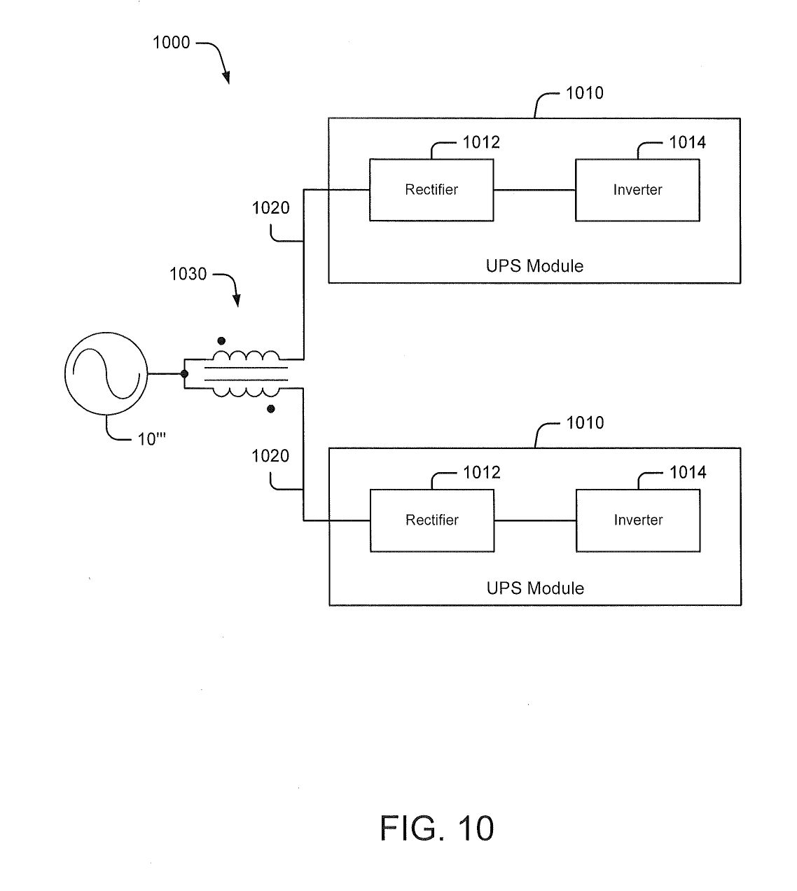

FIG. 10 illustrates a UPS system 1000 including at least two UPS modules 1010, each including a rectifier circuit 1012 and an inverter circuit 1014. Inputs of the rectifier circuit 1012 are coupled in common to a terminal of an AC source 10″ via respective conductors 1020. A differential mode inductor 1030 couples the conductors 1020, and can reduce high-frequency currents passing between the rectifier circuits 1012. The differential mode inductor 930 may be implemented using, for example, conductors coupled in a differential manner through a ferrite ring (e.g., similar to the arrangement shown in FIG. 4) and/or other differential mode inductor arrangements. In systems including three or more paralleled modules, differential mode inductor arrangements similar to those described with reference to FIGS. 5-7 may be used.

It will be further appreciated that, in some embodiments, differential mode inductors may be used for multiple ones of battery, rectifier and inverter connections. For example, referring to FIG. 2, differential mode inductor arrangements similar to those used for the DC/DC converter circuits 216 may also be used for the connections of the inverter circuits 214 to the load 10′″ and/or for the connections of the rectifier circuits 212 to the AC power source 10″.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. An uninterruptible power supply (UPS) system comprising:
at least two UPS modules having respective switchmode power converter circuits coupled in common to a current source/sink by respective conductors; and
at least one differential mode inductor magnetically coupling the at least two conductors.

2. The system of claim 1, wherein the switchmode power converter circuits comprise respective DC/DC converter circuits coupled in common to a terminal of a DC power source by the conductors.

3. The system of claim 2, wherein the DC/DC converter circuits are not synchronized.

4. The system of claim 3, wherein the DC/DC converter circuits operate at variable frequencies.

5. The system of claim 2, wherein the at least two UPS modules further comprise respective inverter circuits having inputs coupled to respective ones of the DC/DC converters and outputs coupled in common to a load.

6. The system of claim 2, wherein the at least one differential mode inductor comprises a ferrite core magnetically coupling the conductors.

7. The system of claim 6, wherein the ferrite core comprises a ferrite ring through which each of the conductors passes at least once.

8. The system of claim 1, wherein the switchmode power converter circuits comprise respective inverter circuits coupled in common to a terminal of a load by the conductors.

9. The system of claim 1, wherein the switchmode power converter circuits comprise respective rectifier circuits coupled in common to a terminal of an AC power source by the conductors.

10. The system of claim 1, wherein the at least two UPS modules comprise at least three UPS modules having respective switchmode power converter circuits coupled in common to the current source/sink by at least three respective conductors and wherein the at least one differential mode inductor comprises a plurality of differential mode inductors, respective ones of which magnetically couple respective pairs of the at least three conductors.

11. The system of claim 10, wherein at least one of the at least three conductors is magnetically coupled to less than all of a remainder of the at least three conductors.

12. A UPS system comprising:
at least two UPS modules, each of which comprises:
an inverter circuit having an output configured to be coupled to load; and
a DC/DC converter circuit coupled to an input of the inverter circuit;
at least two conductors, respective ones of which couple respective ones of the switchmode DC/DC converter circuits of the UPS modules in common to a terminal of a battery; and
at least one differential mode inductor magnetically coupling the at least two conductors.

13. The system of claim 12, wherein the at least two UPS modules comprise at least three UPS modules coupled in common to the terminal of the battery by at least three respective conductors and wherein the at least one differential mode inductor comprises a plurality of differential mode inductors, respective ones of which magnetically couple respective pairs of the at least three conductors.

14. The system of claim 13, wherein at least one of the at least three conductors is magnetically coupled to less than all of a remainder of the at least three conductors.

15. The system of claim 12, wherein the at least one differential mode inductor comprises a
a ferrite ring through which each of the at least two conductors passes at least once.

16. The system of claim 12, wherein the inverter circuits of the UPS modules are coupled in common to a load and wherein modulation of the inverter circuits is synchronized.

17. A method of operating a UPS system comprising at least two UPS modules and at least two conductors, respective ones of which couple respective switchmode DC/DC converter circuits of the UPS modules in common to a terminal of a battery, the method comprising:
differential mode inductively coupling the at least two conductors.

18. The method of claim 17, further comprising varying switching frequencies of the switchmode DC/DC converter circuits.

19. The method of claim 17, wherein differential mode inductively coupling the at least two conductors comprises inductively coupling the at least two conductors using a ferrite ring through which each of the at least two conductors passes at least once.

20. The method of claim 17, where the at least two UPS modules comprise at least three UPS modules, wherein the at least two conductors comprises at least three conductors, respective ones of which couple respective switchmode DC/DC converter circuits of the at least three UPS modules in common to the terminal of the battery, and wherein differential mode inductively coupling the at least two conductors comprises coupling respective pairs of the at least three conductors.
